(19) United States
(12) Patent Application Publication
(10) Pub. No.: US 2023/0349576 A1
(43) Pub. Date: Nov. 2, 2023

(54) REFRIGERANT LEAK DETECTION SYSTEM IN AIR CONDITIONING SYSTEM AND CONTROL METHOD OF SAME

(71) Applicant: Yang ZHANG, Hangzhou (CN)

(72) Inventor: Yang ZHANG, Hangzhou (CN)

(73) Assignee: Sanjiu Technology (Hangzhou) Co., Ltd., Hangzhou (CN)

(21) Appl. No.: 18/220,271

(22) Filed: Jul. 11, 2023

(30) Foreign Application Priority Data
Nov. 1, 2022 (CN) 2022113581568

(51) Int. Cl. F24F 11/36; F24F 11/89; F24F 11/64

(52) U.S. Cl. CPC F24F 11/36; F24F 11/89; F24F 11/64

(57) ABSTRACT

The present invention discloses a control method of a refrigerant leak detection system in an air conditioning system, pertaining to the technical field of detecting leak of air conditioning refrigerants, the control method includes steps of: using the first refrigerant leak detector to detect a leak in the outdoor unit; using the second refrigerant leakage detector to detect a leak at a connection point of components; and when the air conditioning system is under functioning for refrigeration, in the event of a leak occurring in the outdoor unit, enabling the first refrigerant leak detector or the second refrigerant leak detector to detect a leak of the refrigerant, closing the first electromagnetic valve and the second electromagnetic valve of the compressor, enabling the condenser fan to discharge the refrigerant from the outdoor unit, and enabling the first exhaust valve and the second exhaust valve to open, to release the refrigerant in the circulation duct, and enabling the condenser fan to discharge the refrigerant. The present invention enables the refrigerant to only recycle in the outdoor unit, not into the indoor unit, and the heat exchange of the refrigerant to carry out through heat exchange plates with water, so that the operating system of the refrigerant is limited to the outdoors, and even if it leaks, it will not affect the indoors, reducing the possibility of dangers.

### FIELD OF THE INVENTION

The present invention relates to the technical field of detecting leak of air conditioning refrigerants, in particular to a refrigerant leak detection system in an air conditioning system and a control method thereof.

### BACKGROUND OF THE INVENTION

In the technical field of existing domestic air conditioners, R410A mostly serves as a refrigerant, and its GWP (global warming potential) is 2200, which is obviously high, without doubt, facing the global goal of carbon neutrality, people have to urgently seek its alternatives. At present, in-depth research on some representative refrigerants such as R32 and R290 has done in the market, either of their ODP values (ozone depletion potential) is zero, their GWP values are far and away lower than the existing refrigerants, and they have been well used in domestic wall-mounted heat-pump air conditioners.

Because the R32 and R290 refrigerants have flammability levels as A2 and A3, it is particularly important to avoid a leak in use, therefore, the indoor and outdoor units are connected with each other by the way of a non-detachable connection, presented as a representative leak-controlling method, which can eliminate the risk of a leak caused by an improper human operation to some extent at the connection.

However, the late-model refrigerant air conditioning system in the art only aims to solve the problem with respect to installation and control the quality in production, but ignores the possible leak caused by the impact on the equipment in use environment. But, once a leak occurs, the feedback of this leak is passive, that is, generally after the leak occurs; the user can passively get the information about it. That is, during leaking, the equipment can still operate, and only after the leakage of the refrigerant reaches a low point or even leaves empty, the user will gradually detect the occurrence of the leak, as the equipment cannot start for functioning. When the leak occurs to this extent, many dangers will occur in the late-model refrigerant air conditioning system, for example, if the leak occurs in indoor equipment, and the continuous leakage will increase the concentration of the refrigerant in the room, which up to the critical concentration point is risked with explosion. In order to avoid such dangers to a certain extent, the late-model refrigerant air conditioning system is constrained with an injection volume, which limits refrigerating effect.

### SUMMARY OF THE INVENTION

An objective of the present invention is to provide a refrigerant leak detection system in an air conditioning system and a control method thereof, so as to solve the technical problem brought with eradicating the diffusion of the refrigerant at the beginning of the leak occurring in the air conditioning system in the prior art, and rooting out possible risks.

The present invention provides a refrigerant leak detection system in an air conditioning system, configured in an air conditioning system including an outdoor unit and an indoor unit, and further including a compressor used to compress a refrigerant, and a circulation duct used to circulate the refrigerant, comprising a second refrigerant leak detector installed on one side of the compressor and a first refrigerant leak detector installed at the air outlet of the outdoor unit, a condenser fan further arranged at the air outlet of the outdoor unit, a first electromagnetic valve and a second electromagnetic valve correspondingly arranged at the connection between the compressor and the inlet and outlet pipes of the circulation duct, and a first exhaust valve and a second exhaust valve correspondingly arranged at the air inlet end and air outlet end of the circulation duct, both ends of which communicate with a heat exchange plate, wherein the other side of the heat exchange plate communicates with a cold water-supplying pipe and a cold water-returning pipe.

Further, the refrigeration system composed of the compressor, the circulation duct, the second refrigerant leak detector, the first electromagnetic valve, the second electromagnetic valve, the first exhaust valve and the second exhaust valve is an integrated system including a plurality of independent refrigeration systems.

A control method of the refrigerant leak detection system in an air conditioning system, comprising the steps of:
Sp1. installing the first refrigerant leak detector in the outdoor unit to detect a leak in the outdoor unit, and enabling the first refrigerant leak detector to be installed below the condenser fan where gas abundantly circulates;
Sp2. installing the second refrigerant leakage detector in the outdoor unit to detect a leak at a connection point of components; and
Sp3. when the air conditioning system is under functioning for refrigeration,
Sp3-1. in the event of a leak occurring in the outdoor unit, enabling the first refrigerant leak detector or the second refrigerant leak detector to detect a leak of the refrigerant, get the information about the leak and provide the leak data to a main control board, which outputs a next instruction;
Sp3-2. enabling the main control board to close the first electromagnetic valve and the second electromagnetic valve of the compressor, and shut off the further output of the refrigerant;
Sp3-3. enabling the condenser fan to operate under full load to discharge the leaked refrigerant from the outdoor unit and reduce the concentration in the outdoor unit; and
Sp3-4. enabling the first exhaust valve and the second exhaust valve to open, to release the refrigerant in the circulation duct, and enabling the condenser fan to discharge the refrigerant.

Further, when the air conditioning system is under functioning for heating, the detection method of this system is the same as the detection method under functioning for refrigeration. Under the conditions of refrigeration and heating, this system can normally detect the leak of the refrigerant, so as to prevent the dangers caused by the leak of the refrigerant.

Further, the first exhaust valve and the second exhaust valve discharge the leaked refrigerant according to a norm that does not exceed an upper limit of an ambient concentration.

Further, in the event of a leak, an indoor wire-controlled buzzer starts, giving an alert about the leak and reminding a householder to repair it in time. In addition, while stopping the circulation of the refrigerant and discharging the leaked refrigerant in time, the buzzer is activated to remind the householder to repair it in time, accurately locate the fault, and prevent the further expansion of the hazard.

Further, all the aforementioned components meet the explosion-proof requirements, with a high safety coefficient.

Further, in the system, the refrigerant only circulates in the outdoor unit, making heat exchange with water through the heat exchange plate, and the cooled or heated water enters an indoor equipment for heat exchange through the circulation formed by the cold water supplying pipe and the cold water returning pipe.

Further, in this system, when the refrigerant is R290 or other refrigerants with high flammability, the outdoor unit adopts multiple sets of independent refrigeration systems, and the multiple sets of independent refrigeration systems use the identical heat exchange plate for heat exchange, and the identical condenser fan for discharging the leaked refrigerant. Meanwhile, in this system, the multiple sets of independent refrigeration systems is independent of each other, and the circulation duct of the multiple sets of independent refrigeration systems are connected in parallel to the circulation duct formed by cold water supplying pipe and the cold water returning pipe for heat exchange. At the time of using R290 or other refrigerants with relatively high flammability, in order to reduce their flammability, one or more independent refrigeration systems are added to the outdoor unit, ensuring sufficient refrigeration capacity. If the outdoor unit has only one circulation system, once a leak occurs, the system will discharge the refrigerant in the duct due to a protection mechanism. The volume of the pumped refrigerant will correspond to the volume of the discharged refrigerant, and a too big volume of the refrigerant locally discharged in a short time will also bring about a risk. But the present invention adopts a plurality of independent refrigeration systems inside the outdoor unit, so this design reduces the injection volume of the refrigerant for a single refrigeration system under the condition that the refrigeration capacity remains unchanged. When a leak occurs, the volume of refrigerant discharged during the leak decreases, at the same time, as the outdoor unit has multiple independent refrigeration systems, one of which is damaged not to such an extent as to affect the operation of the entire system. In long-term functioning, the indoor unit is relatively stable and more energy-saving, and the cooling capacity of the outdoor unit is under functioning with a partial load, so this mode has a more obvious energy-saving effect.

Compared with the prior art, the present invention has the following beneficial effects.

1. In the prior art, exposure of the leak in the air conditioning system mostly occurs at the time that the leakage of the refrigerant reaches a low threshold, or even leaves empty. At this time, the equipment mostly fails in functioning, and the leaked refrigerant is dispersed in the room, and risked with explosion after reaching a higher concentration, so the leak brings a greater hidden safety danger. This detection system and control method confronted with such situations, enable the refrigerant to only recycle in the outdoor unit, not into the indoor unit, and the heat exchange of the refrigerant to only carry out through heat exchange plates with water, so that the operating system of the refrigerant is limited to the outdoors, and even if it leaks, it will not affect the indoors, reducing the possibility of dangers. On the other hand, the first refrigerant leak detector and the second refrigerant leak detector are designed to detect the air outlet where gas abundantly circulates and the connection point of each component, respectively, to ensure that the leak can be detected at the first time. Furthermore, the first electromagnetic valve and the second electromagnetic valve close, to control the compressor to further produce a circulating refrigerant and cut off the circulation of the refrigerant, meanwhile the first exhaust valve and the second exhaust valve open as well as the condenser fan is turned on to discharge the refrigerant leaked in the outdoor unit in time, preventing the refrigerant from dispersing into the room and causing potential hidden safety dangers, or avoiding the explosion danger caused by the increase of refrigerant concentration.

2. At the time of using R290 or other refrigerants with relatively high flammability, in order to reduce their flammability, one or more independent refrigeration systems are added to the outdoor unit, ensuring sufficient refrigeration capacity. If the outdoor unit has only one circulation system, once a leak occurs, the system will discharge the refrigerant in the duct due to a protection mechanism. The volume of the pumped refrigerant will correspond to the volume of the discharged refrigerant, and a too big volume of the refrigerant locally discharged in a short time will also bring about a risk. But the present invention adopts a plurality of independent refrigeration systems inside the outdoor unit, so this design reduces the injection volume of the refrigerant for a single refrigeration system under the condition that the refrigeration capacity remains unchanged. When a leak occurs, the volume of refrigerant discharged during the leak decreases, at the same time, as the outdoor unit has multiple independent refrigeration systems, one of which is damaged not to such an extent as to affect the operation of the entire system. In long-term functioning, the indoor unit is relatively stable and more energy-saving, and the cooling capacity of the outdoor unit is under functioning with a partial load, so this mode has a more obvious energy-saving effect.

### BRIEF DESCRIPTION OF THE DRAWINGS

In order to explain the technical solutions in the embodiments of the present invention or the prior art more clearly, the drawings needing to be used in the descriptions of the embodiments or the prior art are briefly introduced hereinafter. Obviously, the drawings in the following descriptions are only exemplary, and for those of ordinary skills in the art, other drawings may also be derived and obtained based on the provided drawings without going through any creative work.

FIG. 1 is a schematic view of the detection system for a single refrigeration system according to the present invention.

FIG. 2 is a schematic view of the detection system for a plurality of independent refrigeration system according to the present invention.

FIG. 3 is a schematic diagram of another embodiment of a single refrigeration system according to the present invention.

Wherein, 1—first refrigerant leak detector, 2—second refrigerant leak detector, 3—first electromagnetic valve, 4—second electromagnetic valve, 5—first exhaust valve, 6—second exhaust valve, 7—condenser fan, 8—heat exchange plate, 9—cold water-returning pipe, 10—cold water-supplying pipe, 11—cut-off valve.

### DETAILED DESCRIPTION OF SOME EMBODIMENTS

The technical solutions in the embodiments of the present invention will be described clearly and completely below. Of course, the described embodiments are merely some embodiments, rather than all embodiments, of the present invention.

Normally, the components described and shown herein may be configured and designed through various arrangements. Therefore, the detailed description of the embodiments of the present invention provided in the following drawings is not intended to limit the scope of the claimed invention, but only to represent selected embodiments of the present invention.

Based on the embodiments of the present invention, all other embodiments derived by a person of ordinary skill in the art without creative efforts shall fall within the protection scope of the present invention.

In the description of the present invention, it shall be understood that the orientation or position relationship indicated by the terms “center”, “up”, “down”, “left”, “right”, “vertical”, “horizontal”, “inside”, “outside” and the like is based on the orientation or position relationship shown in the accompanying drawings, it is only for the convenience of description of the present invention and simplification of the description, and it is not to indicate or imply that the indicated device or element must have a specific orientation, and be constructed and operated in a specific orientation. Therefore, the terms shall not be understood as limiting the present invention. Moreover, the terms “first”, “second” and “third” are used for descriptive purposes only and cannot be understood as indicating or implying relative importance.

### Example 1

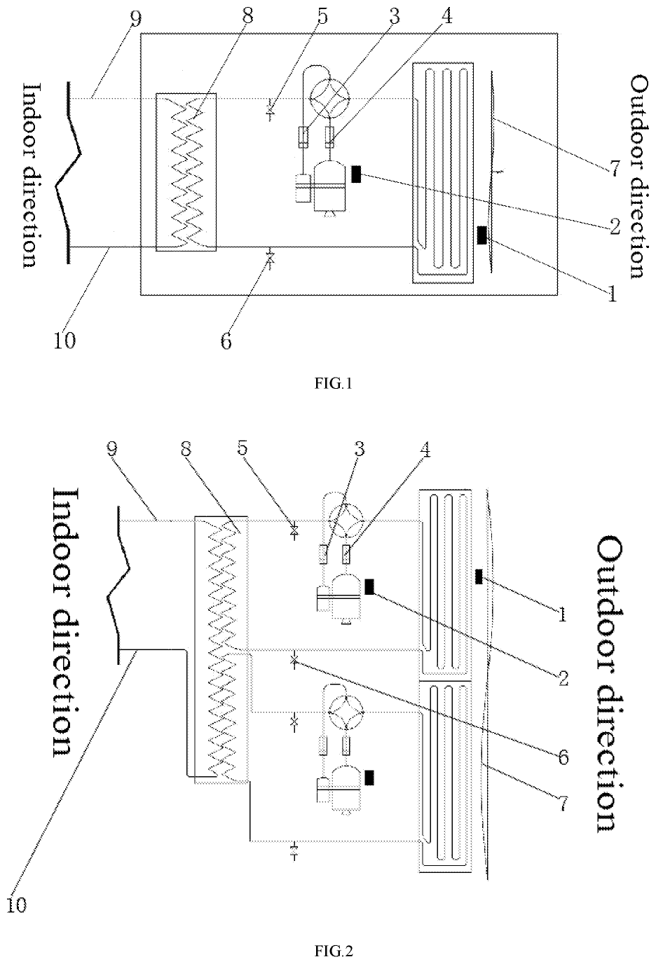

As shown in FIGS. 1-2, this example provides a refrigerant leak detection system in an air conditioning system. This detection system is configured in an air conditioning system including an outdoor unit and an indoor unit, and the air conditioning system further includes a compressor used to compress a refrigerant, and a circulation duct used to circulate the refrigerant. This detection system includes the second refrigerant leak detector 2 installed on one side of the compressor and the first refrigerant leak detector 1 installed at the air outlet of the outdoor unit, wherein, the first refrigerant leak detector 1 and the second refrigerant leak detector 2 are selected according to the type of the refrigerant, for example, the refrigerant leak detectors corresponding to R32 and R290 can be selected. The condenser fan 7 is further arranged at the air outlet of the outdoor unit, the first electromagnetic valve 3 and the second electromagnetic valve 4 are correspondingly arranged at the connection between the compressor and the inlet and outlet pipes of the circulation duct, the first exhaust valve 5 and the second exhaust valve 6 are correspondingly arranged at the air inlet end and air outlet end of the circulation duct, both ends of which communicate with the heat exchange plate 8, the other side of the heat exchange plate 8 communicates with the cold water-supplying pipe 10 and the cold water-returning pipe 9.

Specifically, the refrigeration system composed of the compressor, the circulation duct, the second refrigerant leak detector 2, the first electromagnetic valve 3, the second electromagnetic valve 4, the first exhaust valve 5 and the second exhaust valve 6 is an integrated system including a plurality of independent refrigeration systems.

### Example 2

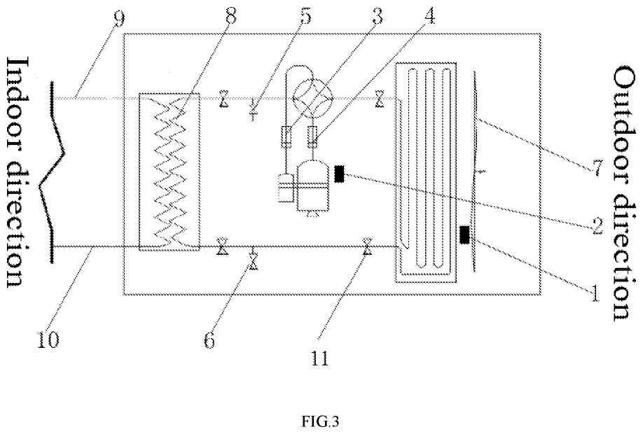

As shown in FIG. 3, in addition four cut-off valves 11 are arranged on the surface of the circulation duct used to circulate the refrigerant; the cut-off valves 11 are an electromagnetic valve, controlled by a control system and divide the circulation duct into four sections. In the event that a leak occurs in the circulation duct, when the first refrigerant leak detector 1 or the second refrigerant leak detector 2 detects a leak of the refrigerant, the cut-off valves 11 close, and the leaking point occurs in any section of the circulation duct between the four cut-off valves. The volume of the leaked refrigerant will only account for a quarter of the total volume of the refrigerant filling in the circulation duct, thereby lowering the upper limit of the refrigerant concentration in the interior of the outdoor unit insufficiently risked with combusting or exploding the refrigerant, and greatly reducing the probability of refrigerant accidents.

### Example 3

A control method of the refrigerant leak detection system in an air conditioning system, comprising the steps of:
Sp1. installing the first refrigerant leak detector 1 in the outdoor unit to detect a leak in the outdoor unit, and enabling the first refrigerant leak detector 1 to be installed below the condenser fan 7 where gas abundantly circulates;
Sp2. installing the second refrigerant leakage detector 2 in the outdoor unit to detect a leak at a connection point of components; and
Sp3. when the air conditioning system is under functioning for refrigeration,
Sp3-1. in the event of a leak occurring in the outdoor unit, enabling the first refrigerant leak detector 1 or the second refrigerant leak detector 2 to detect a leak of the refrigerant, get the information about the leak and provide the leak data to a main control board, which outputs a next instruction;
Sp3-2. enabling the main control board to close the first electromagnetic valve 3 and the second electromagnetic valve 4 of the compressor, and shut off the further output of the refrigerant;
Sp3-3. enabling the condenser fan 7 to operate under full load to discharge the leaked refrigerant from the outdoor unit and reduce the concentration in the outdoor unit; and
Sp3-4. enabling the first exhaust valve 5 and the second exhaust valve 6 to open, to release the refrigerant in the circulation duct, and enabling the condenser fan 7 to discharge the refrigerant.

In the prior art, exposure of the leak in the air conditioning system mostly occurs at the time that the leakage of the refrigerant reaches a low threshold, or even leaves empty. At this time, the equipment mostly fails in functioning, and the leaked refrigerant is dispersed in the room, and risked with explosion after reaching a higher concentration, so the leak brings a greater hidden safety danger. This detection system and control method confronted with such situations, enable the refrigerant to only recycle in the outdoor unit, not into the indoor unit, and the heat exchange of the refrigerant to only carry out through heat exchange plates with water, so that the operating system of the refrigerant is limited to the outdoors, and even if it leaks, it will not affect the indoors, reducing the possibility of dangers. On the other hand, the first refrigerant leak detector 1 and the second refrigerant leak detector 2 are designed to detect the air outlet where gas abundantly circulates and the connection point of each component, respectively, to ensure that the leak can be detected at the first time. Furthermore, the first electromagnetic valve 3 and the second electromagnetic valve 4 close, to control the compressor to further produce a circulating refrigerant and cut off the circulation of the refrigerant, meanwhile the first exhaust valve 5 and the second exhaust valve 6 open as well as the condenser fan 7 is turned on to discharge the refrigerant leaked in the outdoor unit in time, preventing the refrigerant from dispersing into the room and causing potential hidden safety dangers, or avoiding the explosion danger caused by the increase of refrigerant concentration.

Specifically, When the air conditioning system is under functioning for heating, the detection method of this system is the same as the detection method under functioning for refrigeration. Under the conditions of refrigeration and heating, this system can normally detect the leak of the refrigerant, so as to prevent the dangers caused by the leak of the refrigerant.

Specifically, the first exhaust valve 5 and the second exhaust valve 6 discharge the leaked refrigerant according to the norm that does not exceed the upper limit of the ambient concentration.

Specifically, in the event of a leak, the indoor wire-controlled buzzer starts, giving an alert about the leak and reminding the householder to repair it in time. In addition, while stopping the circulation of the refrigerant and discharging the leaked refrigerant in time, the buzzer is activated to remind the householder to repair it in time, accurately locate the fault, and prevent the further expansion of the hazard.

Specifically, all the aforementioned components meet the explosion-proof requirements, with a high safety coefficient.

Specifically, in the system, the refrigerant only circulates in the outdoor unit, making heat exchange with water through the heat exchange plate 8, and the cooled or heated water enters an indoor equipment for heat exchange through the circulation formed by the cold water supplying pipe 10 and the cold water returning pipe 9.

Specifically, in this system, when the refrigerant is R290 or other refrigerants with high flammability, the outdoor unit adopts multiple sets of independent refrigeration systems, and the multiple sets of independent refrigeration systems use the identical heat exchange plate 8 for heat exchange, and the identical condenser fan 7 for discharging the leaked refrigerant. Meanwhile, in this system, the multiple sets of independent refrigeration systems is independent of each other, and the circulation duct of the multiple sets of independent refrigeration systems are connected in parallel to the circulation duct formed by cold water supplying pipe 10 and the cold water returning pipe 9 for heat exchange. At the time of using R290 or other refrigerants with relatively high flammability, in order to reduce their flammability, one or more independent refrigeration systems are added to the outdoor unit, ensuring sufficient refrigeration capacity. If the outdoor unit has only one circulation system, once a leak occurs, the system will discharge the refrigerant in the duct due to a protection mechanism. The volume of the pumped refrigerant will correspond to the volume of the discharged refrigerant, and a too big volume of the refrigerant locally discharged in a short time will also bring about a risk. But the present invention adopts a plurality of independent refrigeration systems inside the outdoor unit, so this design reduces the injection volume of the refrigerant for a single refrigeration system under the condition that the refrigeration capacity remains unchanged. When a leak occurs, the volume of refrigerant discharged during the leak decreases, at the same time, as the outdoor unit has multiple independent refrigeration systems, one of which is damaged not to such an extent as to affect the operation of the entire system. In long-term functioning, the indoor unit is relatively stable and more energy-saving, and the cooling capacity of the outdoor unit is under functioning with a partial load, so this mode has a more obvious energy-saving effect.

Finally, it should be noted that the aforementioned examples are only used to illustrate the technical solution of the present invention, not to limit it. Although the present invention has been described in detail with reference to the aforementioned examples, ordinary technical personnel in this field should understand that they can still modify the technical solutions recorded in the aforementioned examples, or equivalently replace some or all of the technical features; and these modifications or replacements do not make the essence of the corresponding technical solutions deviate from the scope of the various examples of the present invention.

What is claimed is:

1. A refrigerant leak detection system in an air conditioning system, configured in an air conditioning system including an outdoor unit and an indoor unit, and further including a compressor used to compress a refrigerant, and a circulation duct used to circulate the refrigerant, comprising a second refrigerant leak detector (2) installed on one side of the compressor and a first refrigerant leak detector (1) installed at the air outlet of the outdoor unit, a condenser fan (7) further arranged at the air outlet of the outdoor unit, a first electromagnetic valve (3) and a second electromagnetic valve (4) correspondingly arranged at the connection between the compressor and the inlet and outlet pipes of the circulation duct, and a first exhaust valve (5) and a second exhaust valve (6) correspondingly arranged at the air inlet end and air outlet end of the circulation duct, both ends of which communicate with a heat exchange plate (8), wherein the other side of the heat exchange plate (8) communicates with a cold water-supplying pipe (10) and a cold water-returning pipe (9).

2. The refrigerant leak detection system in an air conditioning system according to claim 1, wherein the refrigeration system composed of the compressor, the circulation duct, the second refrigerant leak detector (2), the first electromagnetic valve (3), the second electromagnetic valve (4), the first exhaust valve (5) and the second exhaust valve (6) is an integrated system including a plurality of independent refrigeration systems.

3. A control method of the refrigerant leak detection system in an air conditioning system according to claim 1 or 2, comprising the steps of:
Sp1. installing the first refrigerant leak detector (1) in the outdoor unit to detect a leak in the outdoor unit, and enabling the first refrigerant leak detector (1) to be installed below the condenser fan (7) where gas abundantly circulates;
Sp2. installing the second refrigerant leakage detector (2) in the outdoor unit to detect a leak at a connection point of components; and
Sp3. when the air conditioning system is under functioning for refrigeration,
Sp3-1. in the event of a leak occurring in the outdoor unit, enabling the first refrigerant leak detector (1) or the second refrigerant leak detector (2) to detect a leak of the refrigerant, get the information about the leak and provide the leak data to a main control board, which outputs a next instruction;
Sp3-2. enabling the main control board to close the first electromagnetic valve (3) and the second electromagnetic valve (4) of the compressor, and shut off the further output of the refrigerant;
Sp3-3. enabling the condenser fan (7) to operate under full load to discharge the leaked refrigerant from the outdoor unit and reduce the concentration in the outdoor unit; and
Sp3-4. enabling the first exhaust valve (5) and the second exhaust valve (6) to open, to release the refrigerant in the circulation duct, and enabling the condenser fan (7) to discharge the refrigerant.

4. The control method of the refrigerant leak detection system in an air conditioning system according to claim 3, wherein when the air conditioning system is under functioning for heating, the detection method of this system is the same as the detection method under functioning for refrigeration.

5. The control method of the refrigerant leak detection system in an air conditioning system according to claim 3, wherein the first exhaust valve (5) and the second exhaust valve (6) discharge the leaked refrigerant according to a norm that does not exceed an upper limit of an ambient concentration.

6. The control method of the refrigerant leak detection system in an air conditioning system according to claim 3, wherein in the event of a leak, an indoor wire-controlled buzzer starts, giving an alert about the leak and reminding a householder to repair it in time.

7. The control method of the refrigerant leak detection system in an air conditioning system according to any one of claims 3-6, wherein all the aforementioned components meet the explosion-proof requirements with a high safety coefficient.

8. The control method of the refrigerant leak detection system in an air conditioning system according to claim 3, wherein in the system, the refrigerant only circulates in the outdoor unit, making heat exchange with water through the heat exchange plate (8), and the cooled or heated water enters an indoor equipment for heat exchange through the circulation formed by the cold water supplying pipe (10) and the cold water returning pipe (9).

9. The control method of a refrigerant leak detection system in an air conditioning system according to claim 3, wherein in this system, when the refrigerant is R290 or other refrigerants with high flammability, the outdoor unit adopts multiple sets of independent refrigeration systems, and the multiple sets of independent refrigeration systems use the identical heat exchange plate (8) for heat exchange, and the identical condenser fan (7) for discharging the leaked refrigerant.

10. The control method of a refrigerant leak detection system in an air conditioning system according to claim 9, wherein in this system, the multiple sets of independent refrigeration systems is independent of each other, and the circulation duct of the multiple sets of independent refrigeration systems are connected in parallel to the circulation duct formed by cold water supplying pipe (10) and the cold water returning pipe (9) for heat exchange.
